(19) United States
(12) Patent Application Publication
(10) Pub. No.: US 2026/0289986 A1
(43) Pub. Date: Sep. 24, 2026

(54) METHODS AND SYSTEMS FOR IMPROVED AI MODEL DEVELOPMENT FOR MEDICAL APPLICATIONS

(71) Applicant: KONINKLIJKE PHILIPS N.V., EINDHOVEN (NL)

(72) Inventors: Ahmet Demirkaya, Cambridge, MA (US); Mohsen Zahiri, Cambridge, MA (US); Hyeon Woo Lee, Cambridge, MA (US); Goutam Ghoshal, South Grafton, MA (US); Balasundar Iyyavu Raju, North Andover, MA (US)

(21) Appl. No.: 19/477,169

(22) PCT Filed: Apr. 18, 2024
(86) PCT No.: PCT/EP2024/060463

§ 371 Date: Oct. 21, 2025

Related U.S. Application Data
(60) Provisional application No. 63/460,940, filed on Apr. 21, 2023.

(51) Int. Cl. G06V 10/778

(52) U.S. Cl. CPC G06V 10/7788; G06V 10/7792; G06V 2201/03

(57) ABSTRACT

A method (100) for generating a trained medical image analysis system analysis system, comprising: receiving (120) a plurality of medical images, wherein some of the plurality of medical images are annotated and wherein some of the plurality of medical images are not annotated; training (130), using the annotated medical images, a medical image analysis algorithm (262) to identify/classify features in a medical image and to generate an uncertainty score, the uncertainty score comprising a quantification of confidence of the algorithm identify/classify features in the image; at least one iteration of: (i) analyzing (140), using the trained algorithm, the plurality of images that are not annotated to generate an uncertainty score; (ii) prioritizing (150) for expert annotation, based on the uncertainty scores, a subset of the plurality of medical images; (iii) receiving (160), after expert annotation, the medical images; and (iv) retraining (170), using at least the received medical images, the medical image analysis algorithm.

### FIELD OF THE DISCLOSURE

The present disclosure is directed generally to methods and systems for generating a trained medical image analysis system.

### BACKGROUND

Developing a model for medical detection or classification tasks requires thousands of annotated input images or documents. Completing these annotations can take months to years. Since these annotations are done by experts, the process can be extremely expensive. The more annotations that are necessary to train a model, the longer and more expensive the process can be. In addition to the time and cost associated with exhaustive annotation processes, there are typically other challenges for the AI model developers. As annotation progresses, AI model developers are forced to work with an incomplete (i.e., not fully annotated) dataset, and thus they may not have access to the most impactful data annotations that could increase the model performance. Since model development and data annotation are done in parallel, the incomplete dataset might be biased or might suffer from class imbalances. These limitations result in significant challenges for developers and can lead to poor model performance.

Active Learning methods are used in some domains to address the challenges mentioned above. However, utilizing off-the-shelf active learning methods developed for non-medical domains suffer from significant limitations and challenges when utilized for medical data. For example, prioritization of medical data requires more than just sorting the informativeness of each image. For CT scans, for instance, hundreds of images are obtained in a single scan and the active learning model must assign an informativeness score to the entire scan. In addition to this, with medical data, oftentimes there is additional information available about the data. This additional data can be the subject's age and gender, or any other information that might provide the system with an idea or clue about informativeness. Active learning functions can utilize such information to determine informativeness of input data and boost minority instances, among other positive aspects.

### SUMMARY OF THE DISCLOSURE

Thus, there is a continued methods and systems to efficiently train a model for medical detection or classification using less time and reduced expense, while reducing the human guesswork involved in identifying the most important training data. Various embodiments and implementations described or otherwise envisioned herein are directed to a method and system for generating a trained medical image analysis system. An active learning system receives a plurality of medical images, where some of those medical images are annotated by an expert (where “an expert” can be one expert or multiple experts). Those annotated medical images are utilized to train a medical image analysis algorithm to identify/classify features in a medical image and to generate an uncertainty score for a medical image, where the uncertainty score is a quantification of confidence of the trained medical image analysis algorithm identify/classify features in the medical image. The system then completes one or more iterations of: (i) analyzing unannotated medical images to generate an uncertainty score; (ii) prioritizing, based on the generated uncertainty scores, some of the unannotated medical images for expert annotation; (iii) receiving those annotated medical images; and (iv) retraining the medical image analysis algorithm using at least the received annotated medical images.

According to an aspect, a method for generating a trained medical image analysis system is provided. The method includes: receiving a plurality of medical images, wherein a minority of the plurality of medical images are annotated by one or more experts and wherein a majority of the plurality of medical images are not annotated, an annotation comprising an identification/classification of one or more features in a medical image; training, using at least some of the plurality of medical images annotated by one or more experts, a medical image analysis algorithm to identify/classify the one or more features in a medical image and to generate an uncertainty score for a medical image, the uncertainty score comprising a quantification of confidence of the trained medical image analysis algorithm identify/classify the one or more features in the medical image; at least one iteration of: (i) analyzing, using the trained medical image analysis algorithm, the plurality of medical images that are not annotated to generate an uncertainty score for at least some of the plurality of medical images; (ii) prioritizing for expert annotation, based on the generated uncertainty scores, a subset of the plurality of medical images that are not annotated; (iii) receiving, after expert annotation, the subset of the plurality of medical images; and (iv) retraining, using at least the received annotated subset of the plurality of medical images, the medical image analysis algorithm, wherein an updated trained medical image analysis algorithm is generated upon completion of the retraining.

According to an embodiment, prioritizing comprises identifying a subset of the plurality of medical images with generated uncertainty scores below a predetermined threshold.

According to an embodiment, the method comprises two or more iterations of analyzing, prioritizing, receiving, and retraining.

According to an embodiment, iterations of analyzing, prioritizing, receiving, and retraining are performed until the generated uncertainty scores are above a predetermined threshold.

According to an embodiment, prioritization is further based on one or more demographic parameters.

According to an embodiment, the method further includes the step of analyzing a medical image using the updated trained medical image analysis algorithm, to identify a trauma or abnormality of a subject.

According to an embodiment, the method further includes treating the identified trauma or abnormality, on the basis of identifying the trauma or abnormality of the subject using the analysis by the updated trained medical image analysis algorithm.

According to another aspect, a medical image analysis system is provided. The system includes: an image database comprising a plurality of medical images, wherein a minority of the plurality of medical images are annotated by one or more experts and wherein a majority of the plurality of medical images are not annotated, an annotation comprising an identification/classification of one or more features in a medical image; a trained medical image analysis algorithm configured to identify/classify the one or more features in a medical image and to generate an uncertainty score for a medical image, the uncertainty score comprising a quantification of confidence of the trained medical image analysis algorithm identify/classify the one or more features in the medical image; and a processor configured to perform one or more iterations of: analyzing, using the trained medical image analysis algorithm, the plurality of medical images that are not annotated to generate an uncertainty score for at least some of the plurality of medical images; (ii) prioritizing for expert annotation, based on the generated uncertainty scores, a subset of the plurality of medical images that are not annotated; (iii) receiving, after expert annotation, the subset of the plurality of medical images; and (iv) retraining, using at least the received annotated subset of the plurality of medical images, the medical image analysis algorithm, wherein an updated trained medical image analysis algorithm is generated upon completion of the retraining.

According to an embodiment, the processor is further configured to train, using at least some of the plurality of medical images annotated by one or more experts, a medical image analysis algorithm to identify/classify the one or more features in a medical image and to generate an uncertainty score for a medical image.

According to an embodiment, prioritizing comprises identifying a subset of the plurality of medical images with generated uncertainty scores below a predetermined threshold.

According to an embodiment, the system comprises two or more iterations of analyzing, prioritizing, receiving, and retraining.

According to an embodiment, iterations of analyzing, prioritizing, receiving, and retraining are performed until the generated uncertainty scores are above a predetermined threshold.

According to an embodiment, prioritization is further based on one or more demographic parameters.

According to an embodiment, the processor is further configured to analyze a medical image using the updated trained medical image analysis algorithm, to identify a trauma or abnormality of a subject.

According to an embodiment, further comprising treating the identified trauma or abnormality, on the basis of identifying the trauma or abnormality of the subject using the analysis by the updated trained medical image analysis algorithm.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

These and other aspects of the various embodiments will be apparent from and elucidated with reference to the embodiment(s) described hereinafter.

### BRIEF DESCRIPTION OF THE DRAWINGS

In the drawings, like reference characters generally refer to the same parts throughout the different views. The figures showing features and ways of implementing various embodiments and are not to be construed as being limiting to other possible embodiments falling within the scope of the attached claims. Also, the drawings are not necessarily to scale, emphasis instead generally being placed upon illustrating the principles of the various embodiments.

FIG. 1 is a flowchart of a method for generating a trained medical image analysis system, in accordance with an embodiment.

FIG. 2 is a schematic representation of a medical image analysis system, in accordance with an embodiment.

FIG. 3 is a flowchart of a method for generating a trained medical image analysis system, in accordance with an embodiment.

FIG. 4 is a graph of objects per image for several rounds of active learning, in accordance with an embodiment.

FIG. 5 is a flowchart of a method for training a medical image analysis algorithm of a medical image analysis system, in accordance with an embodiment.

### DETAILED DESCRIPTION OF EMBODIMENTS

The present disclosure describes various embodiments of a system and method configured to train a medical image analysis algorithm. More generally, Applicant has recognized and appreciated that it would be beneficial to provide a method and system to more efficiently train a model for medical detection or classification using less time and reduced expense, while reducing the human guesswork involved in identifying the most important training data. Various embodiments and implementations described or otherwise envisioned herein are directed to a method and system for generating a trained medical image analysis system. An active learning system receives a plurality of medical images, where some of those medical images are annotated by one or more experts. Those annotated medical images are utilized to train a medical image analysis algorithm to identify/classify features in a medical image and to generate an uncertainty score for a medical image, where the uncertainty score is a quantification of confidence of the trained medical image analysis algorithm identify/classify features in the medical image. The system then completes one or more iterations of: (i) analyzing unannotated medical images to generate an uncertainty score; (ii) prioritizing, based on the generated uncertainty scores, some of the unannotated medical images for expert annotation; (iii) receiving those annotated medical images; and (iv) retraining the medical image analysis algorithm at least using the received annotated medical images.

The embodiments and implementations disclosed or otherwise envisioned herein can be utilized with any system that may utilize or benefit from medical model training. For example, one application is to improve automated analysis and detection for many different imaging modalities including ultrasound, MRI, X-ray, and more. However, the disclosure is not limited to these devices or systems, and thus disclosure and embodiments disclosed herein can encompass any system that may utilize or benefit from model training and/or a trained model.

Throughout the specification, embodiments of the methods and systems may be described in conjunction with Focused Assessment with Sonography in Trauma (FAST) exams as an example, although the methods and systems described or otherwise envisioned herein apply to many other medical applications. Ultrasound systems are used as the standard of care for imaging internal bleeding. FAST exams are regularly used as a rapid bedside imaging tool to screen for internal bleeding, such as around the heart or in the abdomen after trauma. The utility of FAST has been widely acknowledged, and it is being used in hospital, prehospital, and combat settings.

Organ detection is a vital aspect of the FAST exam. The FAST exam can comprise an AI-based object detection method in order to detect different organ types or structures, such as the following: liver, liver tip, diaphragm, and kidney. During object detection, one of the main challenges is the annotation speed of the annotators. This is limited by the amount of labeled data that can be utilized to train the algorithm. The percentage of the annotated data does not become greater than a certain amount and this leaves some portion of the data unlabeled. The dataset also suffers from class imbalance, and it's more challenging to detect some of the classes, for instance, the liver tip. In addition to being a hard-to-detect organ, the liver tip appears in only a small portion of the images, whereas some other classes are visible almost in all of the images.

Although some aspects of the methods and systems are described in conjunction with the FAST method, the methods and systems described or otherwise envisioned herein apply to many other medical applications.

According to an embodiment, the methods and systems described or otherwise envisioned herein provide numerous advantages over existing methods. The novel medical image annotation pipeline, which prioritizes training input based on informativeness of unlabeled input images, overcomes numerous disadvantages of the prior art. For example, the novel system avoids unnecessary costs associated with labeling images similar to the images that are already labeled in the training set. Thus, the system avoids the time and cost associated with labeling images that the model is already trained for, and is thus confident about. The system does this by, for example, specifying impactful samples in the dataset to reduce annotation time and cost, and prioritizes subjects, views, videos, and/or images based on informativeness as analyzed by the model. The system can identify instances where the model is having difficulties, and generate queries accordingly. This reduces the size of the input dataset and reduces training time. Additionally, the refined data selection that encourages balancing class distributions. The system identifies the most impactful samples based on the uncertainty of the model rather than manual data selection, and selects critical datasets to understand AI prediction using explainable AI methods. The system therefore creates a more balanced subject distribution by utilizing additional information-other than an image itself-such as age and gender of the subject. The system also assigns an informativeness score at a higher level using a set of instances, such as multiple frames for scoring a video.

According to an embodiment, the methods and systems described or otherwise envisioned herein provide an improved mechanism to select input data for labeling. Intelligently identifying which samples in a training dataset should be prioritized during the annotation process reduces annotation time and costs. This prioritization is based on the informativeness of a new instance, where informativeness is calculated based on the uncertainty of the AI model for that specific instance. Informativeness of an object might be high because of the existence of a minority class or a challenging case for any of the classes. In both cases, labeling such instances and adding them to the labeled dataset would be beneficial for the model, and it would be more impactful compared to just picking an instance at random and labeling that.

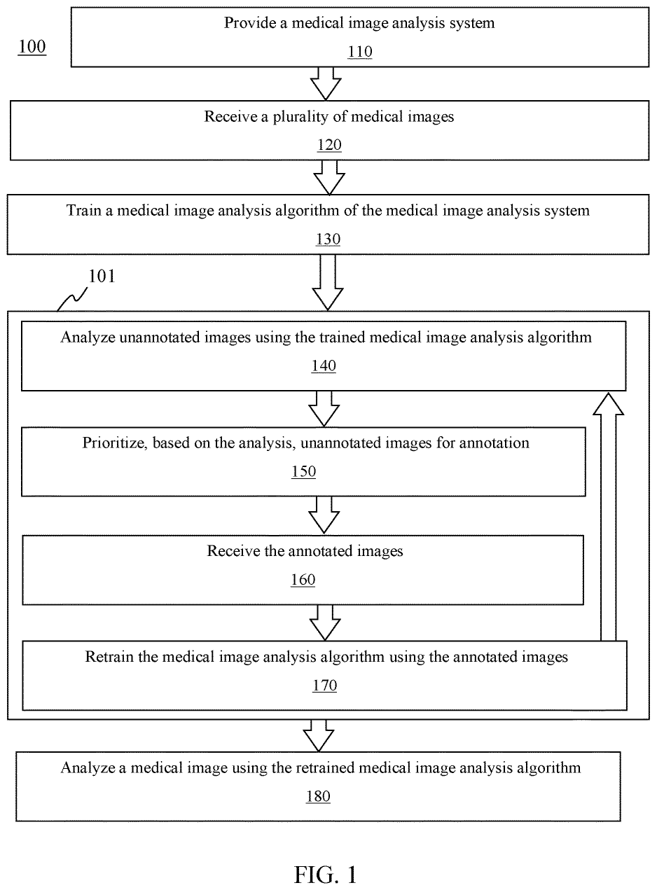

Referring to FIG. 1, in one embodiment, is a flowchart of a method 100 for generating a trained medical image analysis system. The methods described in connection with the figures are provided as examples only, and shall be understood not to limit the scope of the disclosure. The medical image analysis system can be any of the systems described or otherwise envisioned herein. The medical image analysis system can be a single system or multiple different systems.

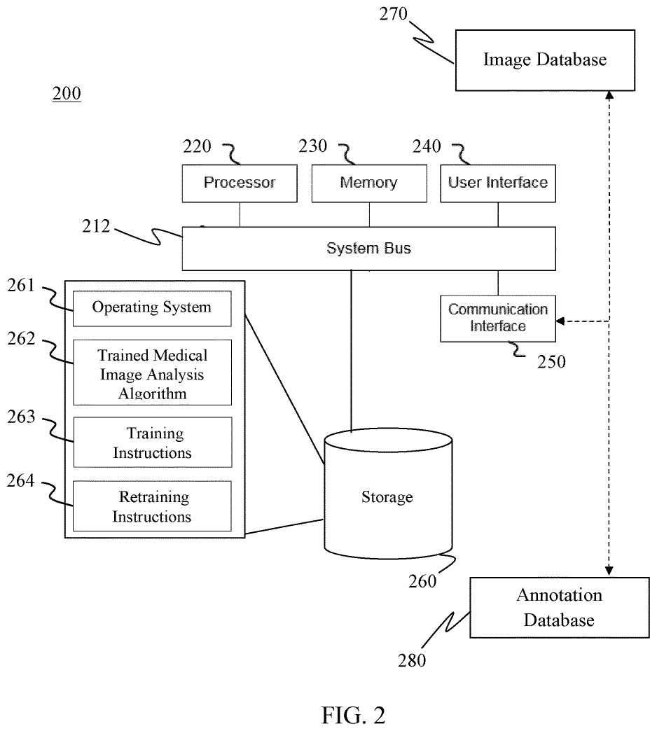

At step 110 of the method, a medical image analysis system 200 is provided. Referring to an embodiment of a medical image analysis system 200 as depicted in FIG. 2, for example, the system comprises one or more of a processor 220, memory 230, user interface 240, communications interface 250, and storage 260, interconnected via one or more system buses 212. It will be understood that FIG. 2 constitutes, in some respects, an abstraction and that the actual organization of the components of the system 200 may be different and more complex than illustrated. Additionally, medical image analysis system 200 can be any of the systems described or otherwise envisioned herein. Other elements and components of the medical image analysis system 200 are disclosed and/or envisioned elsewhere herein.

According to an embodiment, the medical image analysis system 200 comprises or is in direct or indirect communication with an image database 270. The image database may be any image database, and may comprise images or videos or reports or other data obtained using any imaging modality. The most common forms of imaging modality are X-ray, magnetic resonance imaging (MRI), ultrasound, computed tomography scan (CT scan), and nuclear imaging such as Positron Emission Tomography (PET), although many other types of health-or medicine-based imaging modalities are possible. The images obtained using the imaging modality may be obtained from a patient or other individual. The image database 270 may be local to the medical image analysis system, and may optionally be a component of the medical image analysis system. The image database 270 may alternatively be remote to the medical image analysis system, and thus is in direct or indirection communication with the medical image analysis system.

According to an embodiment, the medical image analysis system 200 comprises or is in direct or indirect communication with an annotation database 280. The annotation database 280 is a database of medical images that have been annotated by human or by an AI method. For example, experts in the imaging modality and imaging scope may receive one or more images from the image database 270, annotate the image accordingly, and the annotated image can be added to the annotation database 280. The annotation database 280 may be local to the medical image analysis system, and may optionally be a component of the medical image analysis system. The annotation database 280 may alternatively be remote to the medical image analysis system, and thus is in direct or indirection communication with the medical image analysis system.

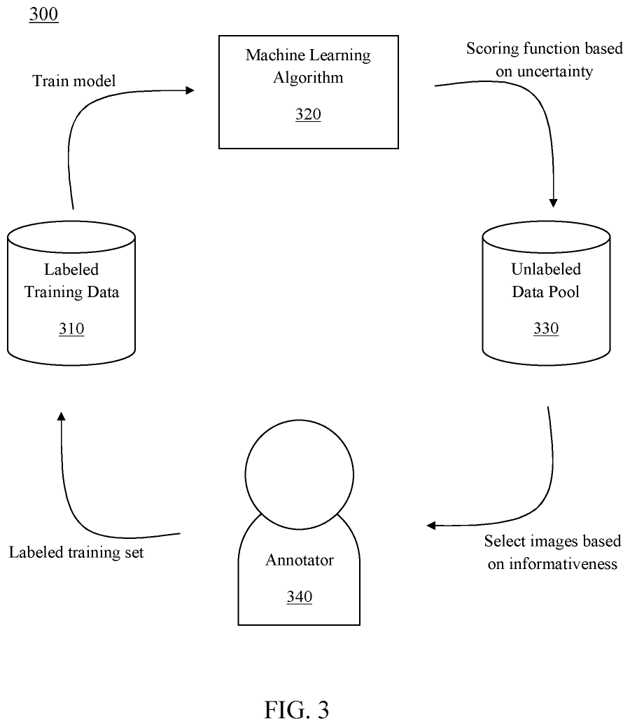

Referring to FIG. 3, in one embodiment, is a flowchart 300 of a method for generating a trained medical image analysis system. According to an embodiment, the methods and systems described or otherwise envisioned herein begin with developing a trained machine learning model 320 using an initial labeled training dataset 310. This machine learning model is trained to analyze medical images, and is trained to score unlabeled images based on their uncertainty as determined by the model, where uncertainty is a quantification of confidence of the trained medical image analysis algorithm to identify/classify one or more features in the medical image. Accordingly, the trained machine learning model performs a scoring function based on uncertainty, to generate an unlabeled data pool 330 (or to identify within an unlabeled data pool) comprising a plurality of unlabeled medical images at least some of which comprise an uncertainty score. The system selects the most informative instances (i.e., the most informative images, which are images predicted to have the biggest impact on training the model if those images were labeled, where informativeness is directly commensurate with the uncertainty score) in the unlabeled data pool 330 for expert labeling. An annotator 340 annotates the prioritized instances in the unlabeled data pool. The annotator 340 may be a human annotator or an algorithmic annotator. The labeled instances are then added to a labeled training dataset 310, which is utilized to retrain the machine learning algorithm 320.

According to an embodiment, the methods and systems described or otherwise envisioned herein thus comprises a novel system that relies on an AI model's uncertainty to prioritize the annotation of unlabeled instances. Notably, the system can perform prioritization at different levels. This could be the prioritization of some subjects or prioritization of some images. The methods are capable of sorting the subjects or any group of images in a better way compared to just averaging the informativeness of each image in that group. This is accomplished with the help of additional steps that can be applied while assigning uncertainty to a group of images. These steps include eliminating outlier uncertainties, focusing only on some portion of the uncertainty values, and non-linear operations such as getting the maximum of a percentile of images. In addition to these additional steps in the informativeness assignment, the approach can boost labeling of minority classes and challenging classes. This prioritization leads to labeling more instances from a minority or challenging class, which helps the AI model to excel with a smaller number of annotations. This system utilizes AI algorithms that detect organs, and can be extended to various AI-based medical data tasks.

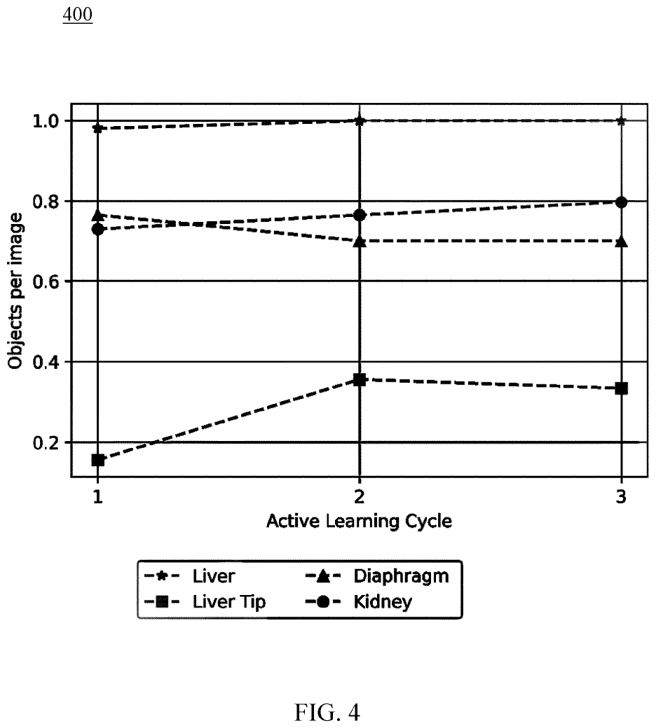

Referring to FIG. 4, in one embodiment, is a graph 400 of objects per image for several rounds of active learning. In this example, active learning was utilized to select images to be labeled in a FAST exam. The results demonstrate that the model encourages labeling of the minority class. Even though only 20% of the images contain liver tips, at later steps, 40% of the images chosen by the active learning model contain liver tips.

Returning to method 100 in FIG. 1, at step 120 of the method, the medical image analysis system receives, retrieves, or otherwise obtains a plurality of medical images, such as a plurality of images from the image database 270. According to an embodiment, the plurality of images are of two different types. The first type are annotated images, which comprise an annotation that is an identification/classification of one or more features in the medical image. For example, the images may have been analyzed by expert annotators, which may be humans or a trained annotation algorithm, and are annotated. Annotation may comprise any modification of the medical image. For example, an annotation may comprise an identification of one or more structures within an image, a classification of one or more structures within an image, an indication, definition, mark, drawing, handwriting, and/or any other annotation that may be used as input data for a medical image analysis algorithm. Thus, a feature may be an organ, a portion of an organ, an internal or external structure, or another anatomical aspect, component, or feature.

The second type of plurality of images, which are typically a majority of the plurality of medical images, are unannotated medical images. These images do not yet comprise an annotation.

According to an embodiment, the medical image analysis algorithm is being trained for a very specific analysis, such as a specific identification/classification of specific feature(s) in a medical image. Thus, the received plurality of medical images are specific to that specific identification/classification of specific feature(s) in a medical image. For example, the received plurality of medical images may be a single imaging modality, a specific type of exam, and/or another specific input parameter for training of the medical image analysis algorithm.

Images may be received in any quantity according to any mechanism. For example, images may be received in batches, and those batches may be randomized or selected according to any other methodology. The images may be received as a stream, as a batch, or in any other quantity or process, and may be stored locally for downstream use or may be utilized immediately in downstream steps of the method.

At step 130 of the method, a medical image analysis algorithm is trained using at least some of the plurality of medical images annotated by the one or more experts. The medical image analysis algorithm can be any algorithm, classifier, or model capable of creating the output, including but not limited to machine learning algorithms, classifiers, and other algorithms. The trained algorithm is a unique algorithm based on the training data used to train the algorithm. Once generated, the trained medical image analysis algorithm can be utilized or deployed immediately, or it may be stored in local and/or remote memory for future use and/or deployment. Thus, the system comprises a trained medical image analysis algorithm as described or otherwise envisioned herein.

The medical image analysis algorithm is trained using at least some of the plurality of medical images annotated by the one or more experts via known methods for training a machine learning algorithm. According to an embodiment, the medical image analysis algorithm is trained to identify/classify one or more features in a medical image, based on the annotations in the input training data. The one or more features may be any of the features described or otherwise envisioned herein, and thus may be any feature that can be identified or classified in a medical image using an imaging modality.

According to an embodiment, the medical image analysis algorithm is trained to generate an uncertainty score for a medical image. This uncertainty score may be generated for every image, or only for some images. For example, an uncertainty score may only be generated for images in which the one or more features cannot be identified or classified. According to an embodiment, the uncertainty score is a quantification of confidence of the trained medical image analysis algorithm identify/classify the one or more features in the medical image.

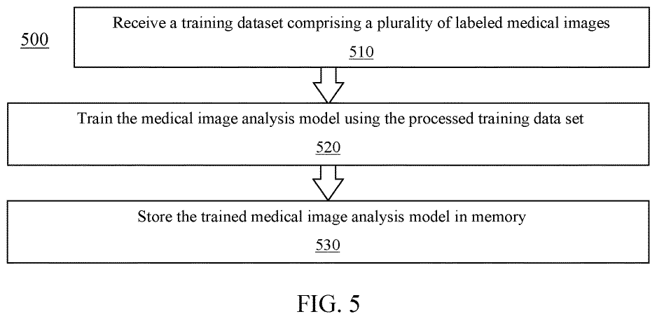

Referring to FIG. 5, in one embodiment, is a flowchart of a method 500 for training the medical image analysis algorithm of the medical image analysis system. This method may be performed by the medical image analysis system, or may be performed by another system such as a specialized medical image model training system.

At step 510 of the method, the system receives a training data set comprising a plurality of labeled medical images. As described or otherwise envisioned herein, the plurality of labeled medical images comprise an annotation that is an identification/classification of one or more features in the medical image. For example, the images may have been analyzed by expert annotators, which may be humans or a trained annotation algorithm, and are annotated. Annotation may comprise any modification of the medical image. For example, an annotation may comprise an identification of one or more structures within an image, a classification of one or more structures within an image, an indication, definition, mark, drawing, handwriting, and/or any other annotation that may be used as input data for a medical image analysis algorithm. This corpus of images may be stored in a database or system or component of the medical image analysis system or a training system, or may be stored in a database or system that is in direct or indirect communication with the medical image analysis system or a training system. According to an embodiment, the medical image analysis 200 comprises or is in direct or indirect communication with an image database 270 and/or annotation database 280 that comprises some or all of the training data set.

According to an embodiment, the training system may comprise a data pre-processor or similar component or algorithm configured to process the received training data. For example, the data pre-processor analyzes the training data to remove noise, bias, errors, and other potential issues. The data pre-processor may also analyze the input data to remove low quality data. Many other forms of data pre-processing or data point identification and/or extraction are possible.

At step 520 of the method, the medical image analysis algorithm is trained using the training dataset comprising the plurality of labeled images. The medical image analysis algorithm is trained, based on the labeling of the plurality of medical images, to identify/classify one or more features in a medical image. The medical image analysis algorithm is trained, based on the labeling of the plurality of medical images, to determine a confidence in the identification/classification of the one or more features in a medical image. A feature may be, for example, an organ, a portion of an organ, an internal or external structure, or another anatomical aspect, component, or feature. Thus, the medical image analysis algorithm is trained to identify the feature, to classify the feature, or to otherwise provide an evaluation of the feature in an image.

The medical image analysis algorithm may generate a confidence score, also called an uncertainty score, in the identification/classification of the one or more features in a medical image. A confidence or uncertainty score may be high when the trained medical image analysis algorithm is able to confidently determine or classify the one or more features in the medical image, and a confidence or uncertainty score may be low when the trained medical image analysis algorithm is not able to confidently determine or classify the one or more features in the medical image. According to an embodiment, confidence or uncertainty scores may be a number between 0 and 1, where 0 is low confidence and 1 is high confidence, although other scoring methods are possible.

According to an embodiment, the model is trained using the training data set according to known methods for training a model. Following training, the system comprises a trained medical image analysis algorithm.

At step 530 of the method, the trained medical image analysis algorithm is stored for future use. According to an embodiment, the trained medical image analysis algorithm may be stored in local or remote storage.

Returning to method 100 in FIG. 1, the trained medical image analysis algorithm can be retrained through active learning and uncertainty sampling via one or more iterations 101 of the method, as described or otherwise envisioned herein.

Accordingly, at step 140 of the method, the trained medical image analysis algorithm analyzes a plurality of unannotated images to generate an uncertainty score. According to an embodiment, a random sampling of medical images are obtained from the image database 270 (e.g., received images from step 120) and are fed into the trained medical image analysis algorithm for analysis. Along with identification/classification of the one or more features in the medical images, the trained medical image analysis algorithm generates a confidence score (also called an uncertainty score) for each medical image analyzed, the confidence score reflecting the algorithm's confidence in the identification/classification of the one or more features in the medical image.

According to an embodiment, the medical image analysis algorithm is trained to generate an uncertainty score for a medical image. This uncertainty score may be generated for every image, or only for some images. For example, an uncertainty score may only be generated for images in which the one or more features cannot be identified or classified. According to an embodiment, the uncertainty score is a quantification of confidence of the trained medical image analysis algorithm identify/classify the one or more features in the medical image.

Thus, the trained medical image analysis algorithm can be utilized for uncertainty sampling to retrain the algorithm in less time with less expense. Uncertainty sampling is a process in which a system identifies items for human review. For example, there may be a goal of helping a system identify human faces in images obtained by video. There are millions of unlabeled images of human faces in these videos, but there is only time or budget to label 10,000 of these images. Randomly sampling 10,000 images from among the millions of unlabeled images for expert labeling will likely identify images for which the trained algorithm is already confident and doesn't require additional training. Accordingly, the system can utilize uncertainty sampling to identify 10,000 images (for expert labeling) that are the most uncertain images, meaning that the model is least confidence or most uncertain about the content of the images. This results in a much bigger impact in retraining of the trained algorithm. There are several methods for uncertainty sampling, and any of those methods may be utilized as described or otherwise envisioned herein. For example, uncertainty sampling may comprise least confidence sampling, smallest/minimum margin sampling, ratio of confidence sampling, or entropy sampling, among other possible methods.

Accordingly, at the end of step 140, the system comprises a plurality of analyzed images, the analyzed images each comprising at least a confidence or uncertainty score, and optionally also comprising the identification/classification of the one or more features, although the identification/classification of the one or more features may be a lack of identification/classification when the trained algorithm is unable to identify or classify a feature (and will thus have a very low confidence score). These analyzed images may be utilized immediately in downstream steps of the method, or they may be stored in local or remote storage for future use by the system.

At step 150 of the method, the generated confidence or uncertainty scores are utilized to prioritize a subset of the analyzed images for expert annotation. For example, the system may be programmed or otherwise configured to select a predetermined number of analyzed images for expert annotation, based on the confidence or uncertainty score associated with those images. The predetermined number of analyzed images may be determined by a user, or may be an automated number of images. For example, the predetermined number may be a specific integer (e.g., 1000 images, 5000 images, etc.) or the predetermined number may be a specific percentage of images analyzed (e.g., 10%, 25%, 50%, etc.). According to another embodiment, the images may be prioritized for expert annotation based on a predetermined threshold for the generated confidence or uncertainty scores associated with the images. For example, the predetermined threshold may be 0.5, where images with a generated confidence or uncertainty score below 0.5 are prioritized for expert annotation. Or the predetermined threshold may be 0.25, where images with a generated confidence or uncertainty score below 0.25 are prioritized for expert annotation. Or the predetermined threshold may be 0.1, where images with a generated confidence or uncertainty score below 0.1 are prioritized for expert annotation. Many other values are possible.

According to an embodiment, the number or percentage or quantity of images prioritized for expert annotation may depend on the budget, resources, or timeframe available for expert annotation. For example, the system may be user-configurable such that the budget or timeframe available for expert annotation is provided to the system and the system determines or estimates a number of images that can be annotated pursuant to that budget or timeframe available for expert annotation. Then, the system may select a number of images with the lowest confidence or uncertainty scores that falls within the estimated number of images that can be annotated. The system may begin, for example, with the image having the lowest confidence or uncertainty score.

According to an embodiment, the medical image analysis system may be configured or programmed or otherwise designed to prioritize the images, thus generating a subset of images for expert annotation, based on a mechanism other than, or in addition to, the prioritization based on the generated confidence or uncertainty score. For example, the medical image analysis system may prioritize the analyzed images based on additional steps that can be applied while assigning uncertainty to a group of images. These steps include eliminating outlier uncertainties, focusing only on some portion of the uncertainty values, and non-linear operations such as getting the maximum of a percentile of images. In addition to these additional steps in the informativeness assignment, the approach can boost labeling of minority classes and challenging classes.

According to an embodiment, the medical image analysis system may prioritize the analyzed images based on-in addition to the generated confidence or uncertainty score demographic information about the subject for which the image was obtained. For example, the demographic information may be the age of the subject, gender of the subject, weight of the subject, diagnosis of the subject, treatment of the subject, and/or any other information that might improving the labeling of minority classes and challenging classes. As just one example, it may be known that the plurality of received medical images comprise a small number or relatively small number of medical images obtained from juvenile subjects compared to adult subjects. Accordingly, hypothesizing that the medical image analysis algorithm will thus not be exposed to many juvenile subject images during the initial training, the system can be programmed to prioritize analyzed medical images with a low confidence score that were obtained from juvenile subjects. Many other examples based on demographic information are possible, and may depend on the diversity or demographic makeup of the medical image database 270 and/or the annotation database 280.

The prioritized subset of images may be utilized immediately in downstream steps of the method, or they may be stored in local or remote storage for future use by the system. For example, the prioritized subset of images may be sent immediately for annotation, or may be stored for future annotation.

According to an embodiment, the prioritized subset of images may be analyzed by an expert annotator, such as a human. The human can be a medical professional or other expert skilled in identifying the one or more features in the medical images for the specific imaging modality. Alternatively, the prioritized subset of images may be analyzed by another algorithm that functions as an expert annotator. This annotation algorithm can be any algorithm trained to identify the one or more features in the medical images. This annotation algorithm may be a component of the medical image analysis system, or may be separate from the medical image analysis system.

At step 160 of the method, the system receives the subset of the plurality of medical images following expert annotation. For example, after annotation, the medical images can be stored in a database such as annotation database 280 for subsequent use by the system. The medical images may be received as they are annotated, may be received in batches, or may be received in full. The annotated images may be utilized immediately or may be stored for downstream use by the system.

At step 170 of the method, the received annotated set of medical images is utilized, along with all or some other images (such as the plurality of medical images, including annotated and/or unannotated medical images) to retrain the medical image analysis algorithm, to generate an updated trained medical image analysis algorithm. The medical image analysis algorithm is trained with the medical images as described or otherwise envisioned herein.

According to an embodiment, steps 140 through 170 of the method may be repeated one or more times. The number of iterations may be predetermined or preprogrammed or may be user defined. Alternatively, the number of iterations may depend on a predetermined limitation. For example, the system may be programmed or designed to perform iterations of the method based on available time or budget. A time limit may determine that no more iterations can be completed within that time. A budget may determine that no more iterations can be completed within that budget amount. As another alternative, the number of iterations may depend on outcomes of training. For example, the system may be programmed or designed to perform iterations of the method until the confidence or uncertainty scores all fall below a predetermined threshold (for example, all confidence or uncertainty scores are below 0.1 or 0.25, etc.). As another example, the system may be programmed or designed to perform iterations of the method until an average, mean, mode, percentile, or any other threshold or analytical value of the confidence or uncertainty scores fall below a predetermined threshold. For example, the system may perform an iteration if the average of the confidence or uncertainty scores from the previous iteration was below 0.75, or below 0.5, and so on. Any method or value for measuring, estimating, or otherwise determining completion of the analysis can be utilized.

Thus, following the determined number of iterations of steps 140 through 170, the medical image analysis system comprises a retrained medical image analysis algorithm configured to analyze medical images as described or otherwise envisioned herein. The retrained medical image analysis algorithm can be stored in local and/or remote memory for immediate or future use.

Accordingly, at step 180 of the method, the updated or retrained medical image analysis algorithm is utilized to analyze an unlabeled medical image, for diagnostic or other medical purposes. This comprises a deployment of the fully trained medical image analysis algorithm. The algorithm may be a component of the imaging modality equipment at a medical facility, a component of a patient care device, a software as a service component, or a self-contained component, among other options. The analysis can be utilized by a clinician or diagnostician to make a diagnosis of the subject from which the image was obtained. For example, the identification/classification of the one or more features in the medical image by the fully trained medical image analysis algorithm can be utilized by the clinician or diagnostician to identify trauma or another abnormality in the image, or may be utilized to determine that there is no abnormality or trauma in the image. Once the clinician or diagnostician determines, using the analysis provided by the fully trained medical image analysis algorithm, that the subject is either experiencing trauma or an abnormality or not experiencing trauma or an abnormality, the clinician or diagnostician can administer treatment accordingly. For example, in the case of determining that the subject is experiencing trauma or an abnormality, on the basis of the analysis provided by the fully trained medical image analysis algorithm, the clinician or diagnostician can treat the patient with medication, surgery, or any of a variety of other treatment mechanisms. Accordingly, referring to an embodiment, is a method for treating a subject's trauma or an abnormality, in response to identifying/classifying that trauma or abnormality using the fully trained medical image analysis algorithm.

Referring to FIG. 2 is a schematic representation of a medical image analysis system 200. System 200 may be any of the systems described or otherwise envisioned herein, and may comprise any of the components described or otherwise envisioned herein. It will be understood that FIG. 2 constitutes, in some respects, an abstraction and that the actual organization of the components of the system 200 may be different and more complex than illustrated.

According to an embodiment, system 200 comprises a processor 220 capable of executing instructions stored in memory 230 or storage 260 or otherwise processing data to, for example, perform one or more steps of the method. Processor 220 may be formed of one or multiple modules. Processor 220 may take any suitable form, including but not limited to a microprocessor, microcontroller, multiple microcontrollers, circuitry, field programmable gate array (FPGA), application-specific integrated circuit (ASIC), a single processor, or plural processors.

Memory 230 can take any suitable form, including a non-volatile memory and/or RAM. The memory 230 may include various memories such as, for example L1, L2, or L3 cache or system memory. As such, the memory 230 may include static random access memory (SRAM), dynamic RAM (DRAM), flash memory, read only memory (ROM), or other similar memory devices. The memory can store, among other things, an operating system. The RAM is used by the processor for the temporary storage of data. According to an embodiment, an operating system may contain code which, when executed by the processor, controls operation of one or more components of system 200. It will be apparent that, in embodiments where the processor implements one or more of the functions described herein in hardware, the software described as corresponding to such functionality in other embodiments may be omitted.

User interface 240 may include one or more devices for enabling communication with a user. The user interface can be any device or system that allows information to be conveyed and/or received, and may include a display, a mouse, and/or a keyboard for receiving user commands. In some embodiments, user interface 240 may include a command line interface or graphical user interface that may be presented to a remote terminal via communication interface 250. The user interface may be located with one or more other components of the system, or may located remote from the system and in communication via a wired and/or wireless communications network.

Communication interface 250 may include one or more devices for enabling communication with other hardware devices. For example, communication interface 250 may include a network interface card (NIC) configured to communicate according to the Ethernet protocol. Additionally, communication interface 250 may implement a TCP/IP stack for communication according to the TCP/IP protocols. Various alternative or additional hardware or configurations for communication interface 250 will be apparent.

Storage 260 may include one or more machine-readable storage media such as read-only memory (ROM), random-access memory (RAM), magnetic disk storage media, optical storage media, flash-memory devices, or similar storage media. In various embodiments, storage 260 may store instructions for execution by processor 220 or data upon which processor 220 may operate. For example, storage 260 may store an operating system 261 for controlling various operations of system 200.

It will be apparent that various information described as stored in storage 260 may be additionally or alternatively stored in memory 230. In this respect, memory 230 may also be considered to constitute a storage device and storage 260 may be considered a memory. Various other arrangements will be apparent. Further, memory 230 and storage 260 may both be considered to be non-transitory machine-readable media. As used herein, the term non-transitory will be understood to exclude transitory signals but to include all forms of storage, including both volatile and non-volatile memories.

While system 200 is shown as including one of each described component, the various components may be duplicated in various embodiments. For example, processor 220 may include multiple microprocessors that are configured to independently execute the methods described herein or are configured to perform steps or subroutines of the methods described herein such that the multiple processors cooperate to achieve the functionality described herein. Further, where one or more components of system 200 is implemented in a cloud computing system, the various hardware components may belong to separate physical systems. For example, processor 220 may include a first processor in a first server and a second processor in a second server. Many other variations and configurations are possible.

According to an embodiment, system 200 comprises or is in direct or indirect communication with an image database 270. The image database may be any image database, and may comprise images or videos or reports or other data obtained using any imaging modality. The most common forms of imaging modality are X-ray, magnetic resonance imaging (MRI), ultrasound, computed tomography scan (CT scan), and nuclear imaging such as Positron Emission Tomography (PET), although many other types of health-or medicine-based imaging modalities are possible. The images obtained using the imaging modality may be obtained from a patient or other individual. The image database 270 may be local to the medical image analysis system, and may optionally be a component of the medical image analysis system. The image database 270 may alternatively be remote to the medical image analysis system, and thus is in direct or indirection communication with the medical image analysis system.

According to an embodiment, the medical image analysis system 200 comprises or is in direct or indirect communication with an annotation database 280. The annotation database 280 is a database of medical images that have been annotated by human or by an AI method. For example, experts in the imaging modality and imaging scope may receive one or more images from the image database 270, annotate the image accordingly, and the annotated image can be added to the annotation database 280. The annotation database 280 may be local to the medical image analysis system, and may optionally be a component of the medical image analysis system. The annotation database 280 may alternatively be remote to the medical image analysis system, and thus is in direct or indirection communication with the medical image analysis system.

According to an embodiment, storage 260 of system 200 may store one or more algorithms, modules, and/or instructions to carry out one or more functions or steps of the methods described or otherwise envisioned herein. For example, storage 260 may comprise, among other instructions or data, a trained medical image analysis algorithm 262, training instructions 263, and retraining instructions 264.

According to an embodiment, the trained medical image analysis algorithm 262 is trained to identify/classify one or more features in a medical image. A feature may be, for example, an organ, a portion of an organ, an internal or external structure, or another anatomical aspect, component, or feature. Thus, the medical image analysis algorithm is trained to identify the feature, to classify the feature, or to otherwise provide an evaluation of the feature in an image. The medical image analysis algorithm may generate a confidence score, also called an uncertainty score, in the identification/classification of the one or more features in a medical image. A confidence or uncertainty score may be high when the trained medical image analysis algorithm is able to confidently determine or classify the one or more features in the medical image, and a confidence or uncertainty score may be low when the trained medical image analysis algorithm is not able to confidently determine or classify the one or more features in the medical image.

According to an embodiment, training instructions 263 direct the system to train a medical image analysis algorithm 262 of the medical image analysis system 200. The instructions direct the system to: at step 510 of the method 500 in FIG. 5, for example, receive a training data set comprising a plurality of labeled medical images. At step 520 of the method, the medical image analysis algorithm is trained using the training dataset comprising the plurality of labeled images. The medical image analysis algorithm is trained, based on the labeling of the plurality of medical images, to identify/classify one or more features in a medical image. The medical image analysis algorithm is trained, based on the labeling of the plurality of medical images, to determine a confidence in the identification/classification of the one or more features in a medical image. At step 530 of the method, the trained medical image analysis algorithm is stored for future use.

According to an embodiment, retraining instructions 264 direct the system to perform a retraining of the medical image analysis algorithm 262 of the medical image analysis system 200. Notably, the retraining instructions 264 may be the same as the training instructions 263, or the training instructions 263 may comprise the retraining instructions 264. According to an embodiment, the retraining instructions 264 direct the system to (for one or more iterations): at step 140 of the method 100 in FIG. 1, analyze a plurality of unannotated medical images using the trained medical image analysis algorithm 262; at step 150 of the method, prioritize, based on the output of the analysis including the received uncertainty scores, the unannotated images for expert annotation; at step 160 of the method, receive the annotated plurality of images; and at step 170 of the method, retrain the medical image analysis algorithm using at least the annotated images to generate a retrained medical image analysis algorithm 262 of the medical image analysis system 200. According to an embodiment, retraining instructions 264 are configured to direct the system to determine whether an additional iteration of retraining the medical image analysis algorithm is necessary. The determination may be made according to the methods described or otherwise envisioned herein.

According to an embodiment, the medical image analysis system 200 is configured to process many thousands or millions of datapoints in the input data used to train the medical image analysis algorithm 262, such as via the training instructions 263. For example, generating a functional and skilled trained medical image analysis algorithm from a corpus of training data requires processing of millions of datapoints from input data and generated features. This can require millions or billions of calculations to generate a novel trained medical image analysis algorithm from those millions of datapoints and millions or billions of calculations. As a result, each trained medical image analysis algorithm is novel and distinct based on the input data and parameters of the machine learning algorithm, and thus improves the functioning of the medical image analysis system. Generating a functional and skilled fully trained medical image analysis algorithm comprises a process with a volume of calculation and analysis that a human brain cannot accomplish in a lifetime, or multiple lifetimes.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.” The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

While several inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

1. A method for generating a trained medical image analysis system, comprising:
receiving a plurality of medical images, wherein a minority of the plurality of medical images are annotated by one or more experts and wherein a majority of the plurality of medical images are not annotated, an annotation comprising an identification/classification of one or more features in a medical image;
training using at least some of the plurality of medical images annotated by one or more experts, a medical image analysis algorithm to identify/classify the one or more features in a medical image and to generate an uncertainty score for a medical image, the uncertainty score comprising a quantification of confidence of the trained medical image analysis algorithm identify/classify the one or more features in the medical image;
at least one iteration of:
analyzing, using the trained medical image analysis algorithm, the plurality of medical images that are not annotated to generate an uncertainty score for at least some of the plurality of medical images;
prioritizing for expert annotation, based on the generated uncertainty scores, a subset of the plurality of medical images that are not annotated;
receiving after expert annotation, the subset of the plurality of medical images; and
retraining using at least the received annotated subset of the plurality of medical images, the medical image analysis algorithm, wherein an updated trained medical image analysis algorithm is generated upon completion of the retraining.

2. The method of claim 1, wherein prioritizing comprises identifying a subset of the plurality of medical images with generated uncertainty scores below a predetermined threshold.

3. The method of claim 2, wherein the predetermined threshold is a predetermined percentile.

4. The method of claim 1, comprising two or more iterations of analyzing, prioritizing, receiving, and retraining.

5. The method of claim 1, wherein iterations of analyzing, prioritizing, receiving, and retraining are performed until the generated uncertainty scores are above a predetermined threshold.

6. The method of claim 1, further comprising the step of analyzing a medical image using the updated trained medical image analysis algorithm, to identify a trauma or abnormality of a subject.

7. The method of claim 6, further comprising the step of treating the identified trauma or abnormality, on the basis of identifying the trauma or abnormality of the subject using the analysis by the updated trained medical image analysis algorithm.

8. A medical image analysis system, comprising:
an image database comprising a plurality of medical images, wherein a minority of the plurality of medical images are annotated by one or more experts and wherein a majority of the plurality of medical images are not annotated, an annotation comprising an identification/classification of one or more features in a medical image;
a trained medical image analysis algorithm configured to identify/classify the one or more features in a medical image and to generate an uncertainty score for a medical image, the uncertainty score comprising a quantification of confidence of the trained medical image analysis algorithm identify/classify the one or more features in the medical image; and
a processor configured to perform one or more iterations of: analyzing, using the trained medical image analysis algorithm, the plurality of medical images that are not annotated to generate an uncertainty score for at least some of the plurality of medical images; (ii) prioritizing for expert annotation, based on the generated uncertainty scores, a subset of the plurality of medical images that are not annotated; (iii) receiving, after expert annotation, the subset of the plurality of medical images; and (iv) retraining, using at least the received annotated subset of the plurality of medical images, the medical image analysis algorithm, wherein an updated trained medical image analysis algorithm is generated upon completion of the retraining.

9. The system of claim 8, wherein the processor is further configured to train, using at least some of the plurality of medical images annotated by one or more experts, a medical image analysis algorithm to identify/classify the one or more features in a medical image and to generate an uncertainty score for a medical image.

10. The system of claim 8, wherein prioritizing comprises identifying a subset of the plurality of medical images with generated uncertainty scores below a predetermined threshold.

11. The system of claim 10, wherein the predetermined threshold is a predetermined percentile.

12. The system of claim 8, comprising two or more iterations of analyzing, prioritizing, receiving, and retraining.

13. The system of claim 8, wherein iterations of analyzing, prioritizing, receiving, and retraining are performed until the generated uncertainty scores are above a predetermined threshold.

14. The system of claim 8, wherein the processor is further configured to analyze a medical image using the updated trained medical image analysis algorithm, to identify a trauma or abnormality of a subject.

15. The system of claim 8, further comprising treating the identified trauma or abnormality, on the basis of identifying the trauma or abnormality of the subject using the analysis by the updated trained medical image analysis algorithm.

16. A non-transitory, computer readable medium, comprising instructions that in response to execution on a processor, cause the processor to:
receive a collection of medical images, wherein a portion of the collection is annotated by at least one expert and a remaining portion is unannotated, each annotation comprising identification or classification of one or more features within a medical image;
executing at least one cycle comprising:
analyzing, by a trained medical image analysis algorithm, at least some of the unannotated medical images to generate uncertainty scores, wherein the medical image analysis algorithm training used at least the annotated portion of the collection to enable identification or classification of the one or more features and to generate an uncertainty score for a medical image, the uncertainty score representing a confidence level of the identification or classification by the algorithm;
selecting, based on the uncertainty scores, a subset of the unannotated medical images for expert annotation;
receiving expert annotations for the selected subset; and
retraining the medical image analysis algorithm using at least the newly annotated subset, thereby producing an updated medical image analysis algorithm;
wherein the updated medical image analysis algorithm is configured to identify or classify features in medical images and to generate uncertainty scores, and wherein the iterative training continues until a predetermined performance criterion is met.

17. The non-transitory computer readable medium of claim 16, wherein selecting comprises identifying a subset of the unannotated medical images with uncertainty scores below a predetermined threshold.

18. The non-transitory computer readable medium of claim 17, wherein the predetermined threshold is a predetermined percentile.

19. The non-transitory computer readable medium of claim 16, comprising two or more cycles of analyzing, selecting, receiving, and retraining.

20. The non-transitory computer readable medium of claim 16, wherein the iterative training continues until the uncertainty scores for the medical images are above a predetermined threshold.
